(19) United States
(12) Patent Application Publication
(10) Pub. No.: US 2020/0026210 A1
(43) Pub. Date: Jan. 23, 2020

(54) TONER, TONER STORAGE UNIT, AND IMAGE FORMING APPARATUS

(71) Applicants: Yu HIRAI, Shizuoka (JP); Masayuki Ishii, Shizuoka (JP); Hyo Shu, Shizuoka (JP); Masayuki Kakimoto, Shizuoka (JP); Yoshitaka Sekiguchi, Kanagawa (JP); Shohta Kobayashi, Shizuoka (JP); Shinya Hanatani, Kanagawa (JP); Kohtaroh Ogino, Shizuoka (JP); Yasuaki Iwamoto, Shizuoka (JP)

(72) Inventors: Yu HIRAI, Shizuoka (JP); Masayuki Ishii, Shizuoka (JP); Hyo Shu, Shizuoka (JP); Masayuki Kakimoto, Shizuoka (JP); Yoshitaka Sekiguchi, Kanagawa (JP); Shohta Kobayashi, Shizuoka (JP); Shinya Hanatani, Kanagawa (JP); Kohtaroh Ogino, Shizuoka (JP); Yasuaki Iwamoto, Shizuoka (JP)

(21) Appl. No.: 16/398,867

(22) Filed: Apr. 30, 2019

(30) Foreign Application Priority Data
Jul. 18, 2018 (JP) 2018-134712

(51) Int. Cl. G03G 9/09; G03G 15/08; G03G 9/087; G03G 9/097; G03G 9/08

(52) U.S. Cl. CPC G03G 9/091; G03G 15/0865; G03G 9/08755; G03G 9/0904; G03G 9/0827; G03G 9/0819; G03G 9/09716; G03G 9/09741

(57) ABSTRACT

A toner is provided. The toner comprises a binder resin, a metal-containing azo dye, and a quaternary ammonium salt, has an average circularity of from 0.85 to 0.95, and is free of a tin compound having Sn—C bond.

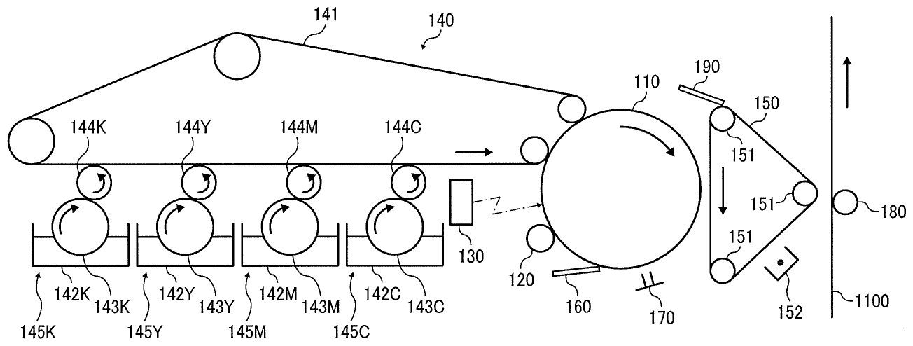

### CROSS-REFERENCE TO RELATED APPLICATIONS

This patent application is based on and claims priority pursuant to 35 U.S.C. § 119(a) to Japanese Patent Application No. 2018-134712, filed on Jul. 18, 2018, in the Japan Patent Office, the entire disclosure of which is hereby incorporated by reference herein.

### BACKGROUND

### Technical Field

The present disclosure relates to a toner, a toner storage unit, and an image forming apparatus.

### Description of the Related Art

Image forming apparatuses such as multifunction peripherals (MFPs) and printers using toner are widely used in various places such as offices. As opportunities to use the toner are expanded, demands for the toner have been diversified such as low environmental load, high functionality accompanied by downsizing of the image forming apparatuses, and reduction of contamination of photoconductors (OPC).

As catalysts for use in the production of binder resins contained in the toner, various tin compounds and titanium compounds have been studied taking into consideration not only their catalytic activity but also their influence on toner performance such as chargeability. Toner quality is significantly influenced depending on the type of the catalyst. There has been an attempt to positively control chargeability of the toner by using a charge control agent at the time of production of the toner. There has been another attempt to provide more suitable chargeability by simultaneously using positive and negative charge control agents.

Furthermore, in recent years, colorization of output images has progressed, and demands for high image quality and reliable image quality have become stronger than ever. Therefore, in addition to environmental considerations, the toner is also required to improve image quality.

### SUMMARY

In accordance with some embodiments of the present invention, a toner is provided. The toner comprises a binder resin, a metal-containing azo dye, and a quaternary ammonium salt, has an average circularity of from 0.85 to 0.95, and is free of a tin compound having Sn—C bond.

In accordance with some embodiments of the present invention, a toner storage unit is provided. The toner storage unit includes a container and the above-described toner stored in the container.

In accordance with some embodiments of the present invention, an image forming apparatus is provided. The image forming apparatus includes: an electrostatic latent image bearer; an electrostatic latent image forming device configured to form an electrostatic latent image on the electrostatic latent image bearer; a developing device containing the above-described toner, configured to develop the electrostatic latent image formed on the electrostatic latent image bearer with the toner to form a toner image; a transfer device configured to transfer the toner image formed on the electrostatic latent image bearer onto a surface of a recording medium; and a fixing device configured to fix the toner image on the surface of the recording medium.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawing, which is intended to depict example embodiments of the present invention and should not be interpreted to limit the scope thereof. The accompanying drawing is not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to an embodiment of the present invention, a toner that provides excellent image quality with low environmental load and good charge rising property without adhering to a photoconductor is provided.

### Toner

The toner according to an embodiment of the present invention contains a binder resin, a metal-containing azo dye, and a quaternary ammonium salt. The toner further preferably contains a silica and a silicone oil, and optionally contains other components as required.

In addition, the toner is free of a tin compound having Sn—C bond.

Although “toner with low environmental load” may be defined in various ways, in the present disclosure, “toner with low environmental load” refers to a toner produced without using an organic tin (Sn) catalyst typified by a tin compound having Sn—C bond. That is, “toner with low environmental load” refers to a toner using a binder resin synthesized without using a tin compound having Sn—C bond (i.e., an organic Sn catalyst).

### Binder Resin

The binder resin is not particularly limited and can be appropriately selected according to the purpose. Preferred examples of the binder resin include a polyester resin, for low-temperature fixability and environmental safety (free of VOC due to residual monomers).

### Polyester Resin

The polyester resin is obtained by a polycondensation reaction between a generally known alcohol and a generally known carboxylic acid, and a catalyst is generally used in the polycondensation reaction.

As the catalyst, a tin compound having Sn—C bond (i.e., an organotin compound) has been known and widely used for a long time. The organotin compound refers to a compound having a structure in which a carbon atom of a functional group having at least one carbon atom is bonded to a tetravalent tin atom. However, the organic tin compound has recently become difficult to use for environmental concerns.

In view of this situation, in the present disclosure, a binder resin produced using a tin compound free of Sn—C bond as a catalyst is used. As a result of using a binder resin produced using a tin compound free of Sn—C bond (hereinafter may be referred to as “tin catalyst free of Sn—C bond”) or a titanium catalyst, the resulting toner is free of a tin compound having Sn—C bond.

Examples of the tin catalyst free of Sn—C bond include, but are not limited to, tin(II) compounds having Sn—O bond, tin(II) compounds having Sn—X bond (where X represents a halogen atom), and titanium catalysts free of Sn—C bond. Among these, tin(II) compounds having Sn—O bond are preferable.

Examples of the tin(II) compounds having Sn—O bond include, but are not limited to, tin(II) carboxylate having a carboxy group having 2 to 28 carbon atoms, alkoxytin(II) having an alkoxy group having 2 to 28 carbon atoms, tin(II) oxide, and tin(II) sulfate.

Examples of the tin(II) carboxylate having a carboxy group having 2 to 28 carbon atoms include, but are not limited to, tin(II) oxalate, tin(II) acetate, tin(II) octanoate, tin(II) 2-ethylhexanoate, tin(II) laurate, tin(II) stearate, and tin(II) oleate.

Examples of the alkoxytin(II) having an alkoxy group having 2 to 28 carbon atoms include, but are not limited to, octyloxytin(II), lauroxytin(II), stearoxytin(II), and oleyloxytin(II).

Examples of the tin(II) compounds having Sn—X bond (where X represents a halogen atom), i.e., halogenated tin(II), include, but are not limited to, tin(II) chloride and tin(II) bromide.

Among these, for rapidly charging property and catalytic ability, tin(II) carboxylate represented by (R₃COO)₂Sn (where R₃ represents an alkyl or alkenyl group having 5 to 19 carbon atoms), alkoxytin(II) represented by (R₄O)₂Sn (wherein R₄ represents an alkyl or alkenyl group having 6 to 20 carbon atoms), and tin(II) oxide are preferable; fatty acid tin(II) represented by (R₃COO)₂Sn and tin(II) oxide are more preferable; tin(II) octanoate, tin(II) 2-ethylhexanoate, tin(11) stearate, and tin(11) oxide are much more preferable; and tin(11) 2-ethylhexanoate is particularly preferable.

Examples of the titanium catalysts free of Sn—C bond include, but are not limited to, titanium diisopropylate bistriethanolaminate [Ti(C₆H₁₄O₃N)₂(C₃H₇O)₂], titanium diisopropylate bisdiethanolaminate [Ti(C₄H₁₀O₂N)₂(C₃H₇O)₂], titanium dipentylate bistriethanolaminate [Ti(C₆H₁₄O₃N)₂(C₅H₁₁O)₂], titanium diethylate bistriethanolaminate [Ti(C₆H₁₄O₃N)₂(C₂H₅O)₂], titanium dihydroxyoctylate bistriethanolaminate [Ti(C₆H₁₄O₃N)₂(OHC₈H₁₆O)₂], titanium distearate bistriethanolaminate [Ti(C₆H₁₄O₃N)₂(C₁₈H₃₇O)₂], titanium triisopropylate triethanolaminate [Ti(C₆H₁₄ON)(C₃H₇O)₃], and titanium monopropylate tris(triethanolaminate) [Ti(C₆H₁₄O₃N)₃(C₃H₇O)].

Among these, titanium diisopropylate bistriethanolaminate, titanium diisopropylate bisdiethanolaminate, and titanium dipentylate bistriethanolaminate are preferable, and these are available as commercial products of Matsumoto Trading Co., Ltd.

Preferred examples of the titanium catalysts include, but are not limited to, tetra-n-butyl titanate [Ti(C₄H₉O)₄], tetrapropyl titanate [Ti(C₃H₇O)₄], tetrastearyl titanate [Ti(C₁₈H₃₇O)₄], tetramyristyl titanate [Ti(C₁₄H₂₉O)₄], tetraoctyl titanate [Ti(C₈H₁₇O)₄], dioctyl dihydroxyoctyl titanate [Ti(C₈H₁₇O)₂(OHC₈H₁₆O)₂], and dimyristyl dioctyl titanate [Ti(C₁₄H₂₉O)₂(C₈H₁₇O)₂]. Among these, tetrastearyl titanate, tetramyristyl titanate, tetraoctyl titanate, and dioctyl dihydroxyoctyl titanate are preferable.

These are available by reacting a titanium halide with the corresponding alcohol, or as commercial products of Nippon Soda Co., Ltd.

As the polyester resin, all polyester resins obtained by a polycondensation reaction between a generally known alcohol and a generally known carboxylic acid can be used.

Examples of the alcohol include, but are not limited to, diols, etherified bisphenols, divalent alcohol monomers obtained by substituting these alcohols with a saturated or unsaturated hydrocarbon group having 3 to 22 carbon atoms, and higher alcohol monomers having a valence of 3 or more.

Examples of the diols include, but are not limited to, polyethylene glycol, diethylene glycol, triethylene glycol, 1,2-propylene glycol, 1,3-propylene glycol, 1,4-propylene glycol, neopentyl glycol, and 1,4-butenediol.

Examples of the etherified bisphenols include, but are not limited to, 1,4-bis(hydroxymethyl)cyclohexane, bisphenol A, hydrogenated bisphenol A, polyoxyethylenated bisphenol A, and polyoxypropylenated bisphenol A.

Examples of the higher alcohol monomers having a valence of 3 or more include, but are not limited to, sorbitol, 1,2,3,6-hexanetetrol, 1,4-sorbitan, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Each of these compounds can be used alone or in combination with others.

Examples of the carboxylic acid include, but are not limited to, monocarboxylic acids, divalent organic acid monomers, anhydrides of these acids, dimers of lower alkyl esters with linolenic acid, and polyvalent carboxylic acid monomers having a valence of 3 or more.

Examples of the monocarboxylic acids include, but are not limited to, palmitic acid, stearic acid, and oleic acid.

Examples of the divalent organic acid monomers include, but are not limited to, maleic acid, fumaric acid, mesaconic acid, citraconic acid, terephthalic acid, cyclohexanedicarboxylic acid, succinic acid, adipic acid, sebacic acid, malonic acid, and these acids substituted with a saturated or unsaturated hydrocarbon group having 3 to 22 carbon atoms.

Examples of the polycarboxylic acid monomers having a valence of 3 or more include, but are not limited to, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, tetra(methylenecarboxyl)methane, 1,2,7,8-octanetetracarboxylic acid, enpol trimmer acid, and anhydrides of these acids.

Each of these compounds can be used alone or in combination with others.

### Metal-Containing Azo Dye

The metal-containing azo dye acts as a negative charge control agent in the toner.

The metal-containing azo dye is not particularly limited and can be appropriately selected according to the purpose. Examples of the metal-containing azo dye include, but are not limited to, iron azo complexes, chromium azo complexes, and cobalt azo complexes. Each of these compounds can be used alone or in combination with others. Among these, iron azo complexes are preferable for charge stability.

The content of the metal-containing azo dye is preferably from 0.5 to 5 parts by mass, and more preferably from 1.0 to 3 parts by mass, with respect to 100 parts by mass of the binder resin. When the content is from 0.5 to 5 parts by mass, good charge rising property is advantageously provided.

### Quaternary Ammonium Salt

The quaternary ammonium salt acts as a positive charge control agent in the toner.

The quaternary ammonium salt is not particularly limited and can be appropriately selected according to the purpose as long as it is a generally-used component for toners.

The content of the quaternary ammonium salt is preferably from 0.1 to 3 parts by mass, and more preferably from 0.5 to 2 parts by mass, with respect to 100 parts by mass of the binder resin. When the content is from 0.1 to 3 parts by mass, an excessive increase of toner charge over time is advantageously prevented.

### Other Components

The other components are not particularly limited and can be appropriately selected according to the purpose as long as they are usable for ordinary toners. Examples of the other components include, but are not limited to, a colorant, a release agent, and an external additive.

### Colorant

As the colorant, known pigments and dyes capable of providing toners of yellow, magenta, cyan, and black colors can be used. Examples of the colorant are described below.

Examples of yellow pigments include, but are not limited to, Cadmium Yellow, Mineral Fast Yellow, Nickel Titanium Yellow, Naples Yellow, Naphthol Yellow S, Hansa Yellow G, Hansa Yellow 10G, Benzidine Yellow GR, Quinoline Yellow Lake, Permanent Yellow NCG, and Tartrazine Lake.

Examples of orange pigments include, but are not limited to, Molybdenum Orange, Permanent Orange GTR, Pyrazolone Orange, Vulcan Orange, Indanthrene Brilliant Orange RK, Benzidine Orange G, and Indanthrene Brilliant Orange GK.

Examples of red pigments include, but are not limited to, red iron oxide, Cadmium Red, Permanent Red 4R, Lithol Red, Pyrazolone Red, Watching Red calcium salt, Lake Red D, Brilliant Carmine 6B, Eosin Lake, Rhodamine Lake B, Alizarin Lake, and Brilliant Carmine 3B.

Examples of violet pigments include, but are not limited to, Fast Violet B and Methyl Violet Lake.

Examples of blue pigments include, but are not limited to, Cobalt Blue, Alkali Blue, Victoria Blue Lake, Phthalocyanine Blue, metal-free Phthalocyanine Blue, partially-chlorinated Phthalocyanine Blue, Fast Sky Blue, and Indanthrene Blue BC.

Examples of green pigments include, but are not limited to, Chromium Green, chromium oxide, Pigment Green B, and Malachite Green Lake.

Examples of black pigments include, but are not limited to, carbon black, oil furnace black, channel black, lamp black, acetylene black, azine dyes (e.g., aniline black), metal oxides, and composite metal oxides.

Each of these compounds can be used alone or in combination with others.

The proportion of the colorant to the binder resin component in the toner is preferably from 1% to 30% by mass, and more preferably 3% to 20% by mass.

### Release Agent

The release agent is not particularly limited and can be appropriately selected according to the purpose from known release agents. Examples of the release agent include, but are not limited to, low-molecular-weight polyolefin waxes such as low-molecular-weight polyethylene and low-molecular-weight polypropylene; synthetic hydrocarbon waxes such as Fischer-Tropsch wax; natural waxes such as beeswax, carnauba wax, candelilla wax, rice wax, and montan wax; petroleum waxes such as paraffin wax and micro-crystalline wax; higher fatty acids such as stearic acid, palmitic acid, and myristic acid, and metal salts and amides thereof; synthetic ester waxes; and various modified waxes thereof. Each of these compounds can be used alone or in combination with others.

The content of the release agent is preferably from 1 to 8 parts by mass with respect to 100 parts by mass of the binder resin. When the content of the release agent is from 1 to 8 parts by mass, the following undesirable phenomena can be prevented.
The releasing effect in the fixing process is poor due to a small amount of the release agent contained in the toner.
Deterioration of heat-resistant storage stability of the toner and toner filming on the photoconductor are caused due to a large amount of the release agent contained in the toner.

### External Additive

The external additive is not particularly limited and may be appropriately selected according to the purpose. Examples of the external additive include, but are not limited to, lubricants and inorganic particles.

The inorganic particles are not particularly limited and may be appropriately selected according to the purpose. Examples of the inorganic particles include, but are not limited to, silica, alumina, titanium oxide, barium titanate, magnesium titanate, calcium titanate, strontium titanate, fluorine compounds, iron oxide, copper oxide, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride. Each of these materials can be used alone or in combination with others. When using two or more materials in combination, it is preferable that the materials are so selected that the toner is imparted with resistance to stress received in the developing process such as that caused by idling.

Among the above materials, silica is preferred.

Preferably, the silica has a median diameter of from 10 to 80 nm. When the median diameter is from 10 to 80 nm, the following undesirable phenomena can be prevented.
Silica slips through the cleaning blade and adheres to the photoconductor.
Silica makes flaws on the photoconductor.

It is preferable that the surface of the inorganic particles be subjected to a hydrophobizing treatment for adjusting the charge amount of the toner.

The method for hydrophobizing the inorganic particles may be, for example, a method in which the inorganic particles are chemically treated with an organosilicon compound reactive with or physically adsorptive to the inorganic particles.

Examples of the organosilicon compound include a silicone oil. The silicone oil is not particularly limited and can be appropriately selected according to the purpose. Examples of the silicone oil include, but are not limited to, dimethyl silicone oils, alkyl-modified silicone oils, α-methylstyrene-modified silicone oils, fluorine-modified silicone oils, and methyl hydrogen silicone oils.

The method of treating with silicone oil may be, for example, a method of direct mixing silica particles with a silicone oil using a mixer such as a HENSCHEL MIXER, or a method of spraying a silicone oil onto raw silica particles to stir them. Alternatively, a silicone oil may be dissolved or dispersed in a suitable solvent (preferably adjusted to pH 4 with an organic acid etc.) and then mixed with raw silica particles, followed by removal of the solvent. Alternatively, the following method may also be employed in which raw silica particles are put in a reaction vessel, alcohol water is added thereto while stirring under a nitrogen atmosphere, a silicone-oil-based treatment solution is introduced into the reaction vessel to perform surface treatment, and the solvent is removed by heat-stirring.

By treating inorganic particles with a silicone oil, silicone-oil-containing inorganic particles are obtained. For example, by treating silica with a silicone oil, silicone-oil-containing silica is obtained.

### Lubricant

The lubricant is not particularly limited and may be appropriately selected according to the purpose. Examples of the lubricant include, but are not limited to, fatty acid metal salts. Examples of the fatty acid metal salts include, but are not limited to, lead oleate, zinc oleate, copper oleate, zinc stearate, cobalt stearate, iron stearate, copper stearate, zinc palmitate, copper palmitate, and zinc linolenate. Each of these materials can be used alone or in combination with others.

Among these materials, zinc stearate is preferred.

The lubricant may be externally added after a composition containing a binder resin, a colorant, and the like is melt-kneaded and pulverized into particles.

### Toner Properties

The toner according to an embodiment of the present invention has an average circularity of from 0.85 to 0.95. When the average circularity of the toner is higher than 0.95, a photoconductor to which the toner is adhered may be cleaned insufficiently. When the average circularity of the toner is lower than 0.85, defective transfer may occur to cause deterioration of image quality.

### Method of Measuring Average Circularity of Toner

The average circularity may be measured by, for example, a flow particle image analyzer FPIA-3000 manufactured by SYSMEX CORPORATION.

Specifically, the average circularity may be measured as follows. First, 0.1 to 0.5 mL of a surfactant (an alkylbenzene sulfonate) as a dispersant is added to 100 to 150 mL of water from which impure solids have been removed in advance in a container. Further, about 0.1 to 0.5 g of a measurement sample is added thereto. The resulting suspension in which the sample is dispersed is subjected to a dispersion treatment with an ultrasonic disperser for about 1 to 3 minutes. The resulting dispersion liquid having a concentration of 3,000 to 10,000 particles/μL is subjected to a measurement of the average circularity using the above-described instrument. The circularity is determined by the following equation: Circularity=(Perimeter of the circle having an equal area to a projected area)/(Perimeter of the projected area).

### Method of Manufacturing Toner

The toner according to an embodiment of the present invention can be manufactured by producing mother toner particles containing a binder resin, a metal-containing azo dye, and a quaternary ammonium salt, and adding an external additive as necessary.

The mother toner particles may be produced by various methods such as pulverization methods and polymerization methods (e.g., suspension polymerization, emulsion polymerization, dispersion polymerization, emulsion aggregation, emulsion association).

Subsequently, inorganic particles are externally added to the mother toner particles. By mixing and stirring the mother toner particles and the inorganic particles using a mixer, the inorganic particles (as the external additive) become covering the surface of the mother toner particles while being crushed.

The mixer is not particularly limited and known apparatuses can be used as long as powder can be mixed thereby. Examples of the mixer include, but are not limited to, V-type mixer, ROCKING MIXER, LOEDIGE MIXER, NAUTA MIXER, HENSCHEL MIXER, and Q MIXER. It is preferable that the mixer be equipped with a jacket or the like for adjustment of the internal temperature.

The adhesion strength of the inorganic particles to the surface of the mother toner particles can be controlled by changing the peripheral speed of rotating blades of the mixer or changing the mixing/stirring time. When heat is applied to the inside of the mixer, the surface of the mother toner particles gets softened and the inorganic particles can be embedded therein, so that the adhesion strength of the inorganic particles to the surface of the mother toner particles can be controlled.

### Developer

A developer according to an embodiment of the present invention comprises at least the above-described toner and optionally other components such as a carrier.

The developer has excellent transferability and chargeability and is capable of reliably forming high-quality image. The developer may be either a one-component developer or a two-component developer.

The carrier can be suitably selected according to the purpose. Examples of the carrier include, but are not limited to, a magnetic carrier and a resin carrier.

The magnetic carrier preferably comprises magnetic particles. Specific examples of the magnetic particles include, but are not limited to: magnetites; spinel ferrites containing gamma iron oxide; spinel ferrites containing at least one metal (e.g., Mn, Ni, Zn, Mg, and Cu) other than iron; magnetoplumbite ferrites such as barium ferrite; and particulate iron or alloy having an oxidized layer on its surface. Among these, ferromagnetic particles such as iron are preferable particularly when high magnetization is required.

The shape of the carrier may be granular, spherical, or needle-like. For chemical stability, magnetites, spinel ferrites containing gamma iron oxide, and magnetoplumbite ferrites such as barium ferrite are preferable. A resin carrier which has a desired magnetization by containing an appropriate type of magnetic particles in an appropriate amount may also be used. Such a carrier preferably has a magnetization intensity of from 30 to 150 emu/g at 1,000 oersted.

Such a resin carrier may be produced by spraying a melt-kneaded product of magnetic particles and an insulating binder resin by a spray dryer. Specifically, a resin carrier in which magnetic particles are dispersed in a condensed binder can be produced by reacting and curing a monomer or prepolymer in an aqueous medium in the presence of magnetic particles.

Chargeability of the magnetic carrier may be controlled by fixedly adhering positively-chargeable or negatively-chargeable fine particles or conductive fine particles on the surface of the magnetic carrier, or coating the magnetic carrier with a resin.

Examples of the surface coating resin include silicone resin, acrylic resin, epoxy resin, and fluororesin. These resins may contain positively-chargeable or negatively-chargeable particles or conductive particles. Among these resins, silicone resin and acrylic resin are preferable.

Preferably, the mixing ratio between the toner and the magnetic carrier is such that the toner concentration is from 2% to 10% by mass.

### Toner Storage Unit

In the present disclosure, a toner storage unit refers to a unit that has a function of storing toner and that is storing the above toner. The toner storage unit may be in the form of, for example, a toner storage container, a developing device, or a process cartridge.

In the present disclosure, the toner storage container refers to a container storing the toner.

The developing device refers to a device storing the toner and having a developing unit configured to develop an electrostatic latent image into a toner image with the toner.

The process cartridge refers to a combined body of an electrostatic latent image bearer (also referred to as an image bearer or a photoconductor) with a developing unit storing the toner, detachably mountable on an image forming apparatus. The process cartridge may further include at least one of a charger, an irradiator, and a cleaner.

An image forming apparatus in which the toner storage unit is installed can reliably form high-quality and high-definition images for an extended period of time, utilizing the above-described toner that provides excellent image quality with low environmental load and good charge rising property without adhering to a photoconductor.

### Image Forming Apparatus and Image Forming Method

An image forming apparatus according to an embodiment of the present invention includes at least an electrostatic latent image bearer, an electrostatic latent image forming device, and a developing device, and optionally other devices.

An image forming method according to an embodiment of the present invention includes at least an electrostatic latent image forming process and a developing process, and optionally other processes.

The image forming method is preferably performed by the image forming apparatus. The electrostatic latent image forming process is preferably performed by the electrostatic latent image forming device. The developing process is preferably performed by the developing device. Other optional processes are preferably performed by other optional devices.

More preferably, the image forming apparatus includes: an electrostatic latent image bearer; an electrostatic latent image forming device configured to form an electrostatic latent image on the electrostatic latent image bearer; a developing device containing the above-described toner, configured to develop the electrostatic latent image formed on the electrostatic latent image bearer with the toner to form a toner image; a transfer device configured to transfer the toner image formed on the electrostatic latent image bearer onto a surface of a recording medium; and a fixing device configured to fix the toner image on the surface of the recording medium.

More preferably, the image forming method includes: an electrostatic latent image forming process in which an electrostatic latent image is formed on an electrostatic latent image bearer; a developing process in which the electrostatic latent image formed on the electrostatic latent image bearer is developed with the above-described toner to form a toner image; a transfer process in which the toner image formed on the electrostatic latent image bearer is transferred onto a surface of a recording medium; and a fixing process in which the toner image is fixed on the surface of the recording medium.

In the developing device and the developing process, the above-described toner is used. Preferably, the toner image is formed with a developer containing the above-described toner and other components such as a carrier.

### Electrostatic Latent Image Bearer

The electrostatic latent image bearer (also referred to as “photoconductor”) is not limited in material, structure, and size, and can be appropriately selected from known materials. Specific examples of the materials include, but are not limited to, inorganic photoconductors such as amorphous silicon and selenium, and organic photoconductors such as polysilane and phthalopolymethine.

### Electrostatic Latent Image Forming Device

The electrostatic latent image forming device is not particularly limited and can be appropriately selected according to the purpose as long as it is capable of forming an electrostatic latent image on the electrostatic latent image bearer. For example, the electrostatic latent image forming device may include a charger to uniformly charge a surface of the electrostatic latent image bearer and an irradiator to irradiate the surface of the electrostatic latent image bearer with light containing image information.

### Developing Device

The developing device is not particularly limited and can be appropriately selected according to the purpose as long as it is capable of storing the toner and developing the electrostatic latent image formed on the electrostatic latent image bearer with the toner into a toner image (also referred to as “visible image”).

### Other Devices

Examples of the other optional devices include, but are not limited to, a transfer device, a fixing device, a cleaner, a neutralizer, a recycler, and a controller.

An image forming apparatus according to an embodiment of the present invention is described below with reference to the drawing.

One example of the image forming apparatus is illustrated in the drawing. Around a photoconductor drum (hereinafter “photoconductor”) 110 as an image bearer, a charging roller 120 as a charger, an irradiator 130, a cleaner 160 having a cleaning blade, a neutralizing lamp 170 as a neutralizer, a developing device 140, and an intermediate transferor 150 are provided. The intermediate transferor 150 is suspended by a plurality of suspension rollers 151 and is configured to travel endlessly in the direction indicated by arrow in the drawing by a driver such as a motor. A part of the suspension rollers 151 also serves as a transfer bias roller for supplying a transfer bias to the intermediate transferor 150, and is applied with a predetermined transfer bias voltage from a power source. Further, a cleaner 190 having a cleaning blade is also provided for cleaning the intermediate transferor 150. A transfer roller 180 is disposed facing the intermediate transferor 150, as a transfer device for transferring a developed image onto a transfer sheet 1100 as a final transfer material. The transfer roller 180 is supplied with a transfer bias from a power source. Around the intermediate transferor 150, a corona charger 152 as a charge applying device is provided.

The developing device 140 includes a developing belt 141 serving as a developer bearer; and a black (Bk) developing unit 145K, a yellow (Y) developing unit 145Y, a magenta (M) developing unit 145M, and a cyan (C) developing unit 145C each disposed around the developing belt 141.

The developing belt 141 is stretched over a plurality of belt rollers and is configured to travel endlessly in the direction indicated by arrow in the drawing by a driver such as a motor. The developing belt 141 moves at almost the same speed as the photoconductor 110 at the contact portion with the photoconductor 110.

Since the configuration of each developing unit is the same, the following description is made only for the Bk developing unit 145K. In the drawing, the symbols Y, M, and C are added to the numbers given to the units in the respective developing units 145Y, 145M, and 145C corresponding to those in the Bk developing unit 145K, and the explanation is omitted. The Bk developing unit 145K includes: a developing tank 142K storing a high-viscosity high-concentration liquid developer containing toner particles and a carrier liquid; a drawing roller 143K disposed such that the lower part thereof is immersed in the liquid developer in the developing tank 142K; and an application roller 144K for thinning the developer drawn up from the drawing roller 143K and applying it to the developing belt 141. The application roller 144K is conductive and applied with a predetermined bias from a power source.

Next, an operation of the image forming apparatus is described below. Referring to the drawing, the photoconductor 110 is uniformly charged by the charging roller 120 while rotating in the direction indicated by arrow in the drawing, and the irradiator 130 then forms an image with light reflected from a document through an optical system, thus forming an electrostatic latent image on the photoconductor 110. The electrostatic latent image is developed into a toner image as a visible image by the developing device 140. The developer layer on the developing belt 141 peels off from the developing belt 141 remaining in a thin layer state by contact with the photoconductor 110 in the developing region, and transfers to the portion on the photoconductor 110 where the latent image is formed. The toner image developed by the developing device 140 is transferred onto the surface of the intermediate transferor 150 (i.e., primary transfer) at the contact portion with the intermediate transferor 150 (i.e., primary transfer region) where the intermediate transferor 150 is moving at the same speed as the photoconductor 110. In the case of superimposing three or four colors, this transfer process is repeated for each color to form a composite color image on the intermediate transferor 150.

The corona charger 152 for applying a charge to the composite toner image on the intermediate transferor 150 is provided downstream of the contact portion of the photoconductor 110 with the intermediate transferor 150 and upstream of the contact portion of the intermediate transferor 150 with the transfer sheet 1100 with respect to the direction of rotation of the intermediate transferor 150. The corona charger 152 then imparts to the toner image a true charge of the same polarity as the charge polarity of toner particles constituting the toner image, so that the toner image is supplied with a charge sufficient for being transferred onto the transfer sheet 1100. The toner image charged by the corona charger 152 is then transferred in a collective manner (i.e., secondary transfer) onto the transfer sheet 1100 that is conveyed from a sheet feeder in the direction indicated by arrow in the drawing by a transfer bias from the transfer roller 180. The transfer sheet 1100 onto which the toner image has been transferred is separated from the photoconductor 110 by a separation device, subjected to a fixing process by a fixing device, and ejected from the apparatus. On the other hand, after the image transfer, the untransferred toner particles remaining on the photoconductor 110 are removed by the cleaner 160 and the residual charge is removed by the neutralizing lamp 170 in preparation for the next charging. A color image is usually formed of four color toners. In one color image, one to four toner layers are formed. The toner layers go through the primary transfer (transfer from the photoconductor onto the intermediate transfer belt) and the secondary transfer (transfer from the intermediate transfer belt onto the sheet).

### EXAMPLES

Having generally described this invention, further understanding can be obtained by reference to certain specific examples which are provided herein for the purpose of illustration only and are not intended to be limiting. In the following descriptions, “parts” represents “parts by mass” unless otherwise specified.

### Synthesis of Polyester Resin 1

Polyester resin 1 was synthesized from raw materials described in Table 1.

The raw materials were put in a 10-liter four-neck flask equipped with a nitrogen introducing tube, a dewatering tube, a stirrer, and a thermocouple, subjected to a polycondensation reaction at 235 degrees C. in a nitrogen atmosphere until the acid value reached 4.5 mgKOH/g, and further allowed to react at 8 kPa until the softening point reached 131 degrees C., thus obtaining the polyester resin 1.

The reaction time required for the acid value to reach 4.5 mgKOH/g was 21 hours.

### Synthesis of Polyester Resin 2

Polyester resin 2 was synthesized from raw materials described in Table 1.

The polyester resin 2 was obtained in the same manner as the polyester resin 1 except that the alcohol components were put in the four-neck flask and heated to 100 degrees C. first, then each of the carboxylic acid components and the catalyst were collectively added thereto in a sequential manner at an interval of 3 minutes while stirring.

The reaction time required for the acid value to reach 4.8 mgKOH/g was 13 hours.

### Synthesis of Polyester Resin 3

Polyester resin 3 was synthesized from raw materials described in Table 1.

The polyester resin 3 was obtained in the same manner as the polyester resin 1 except that the alcohol components were put in the four-neck flask and heated to 100 degrees C. first, then each of the catalyst and the carboxylic acid components were collectively added thereto in a sequential manner at an interval of 3 minutes while stirring.

The reaction time required for the acid value to reach 5.3 mgKOH/g was 12 hours.

### Synthesis of Polyester Resin 4

Polyester resin 4 was synthesized from raw materials described in Table 1.

The polyester resin 4 was obtained in the same manner as the polyester resin 1 except that the alcohol components were put in the four-neck flask and heated to 100 degrees C. first, then each of the carboxylic acid components and the catalyst were collectively added thereto in a sequential manner at an interval of 3 minutes while stirring.

The reaction time required for the acid value to reach 4.9 mgKOH/g was 12 hours.

### Synthesis of Polyester Resin 5

Polyester resin 5 was synthesized from raw materials described in Table 1.

The raw materials were put in a 10-liter four-neck flask equipped with a nitrogen introducing tube, a dewatering tube, a stirrer, and a thermocouple, subjected to a polycondensation reaction at 235 degrees C. in a nitrogen atmosphere until the acid value reached 4.8 mgKOH/g, and further allowed to react at 8 kPa until the softening point reached 131 degrees C., thus obtaining the polyester resin 5.

The reaction time required for the acid value to reach 4.8 mgKOH/g was 18 hours.

The polyester resin 5 was produced using dibutyltin oxide having Sn—C bond as a catalyst. Therefore, the polyester resin 5 contains a compound having Sn—C bond.

TABLE 1

| | | Polyester | Polyester | Polyester | Polyester | Polyester |
|---|---|---|---|---|---|---|
| | | Resin 1 | Resin 2 | Resin 3 | Resin 4 | Resin 5 |
| | | (g) | (g) | (g) | (g) | (g) |
| Alcohol | BPA-PO | 6700 | 4690 | 4690 | — | — |
| Components | BPA-EO | — | 1890 | 1890 | — | — |
| | 1,2-Propanediol | — | — | — | 5360 | — |
| | 1,4-Butenediol | — | — | — | 1340 | — |
| | Ethylene Glycol | — | — | — | — | 3350 |
| | Neopentyl Glycol | — | — | — | — | 3350 |
| Carboxylic | Terephthalic Acid | 2888 | 996 | 996 | 2357 | — |
| Acid | Isophthalic Acid | — | — | — | — | 2423 |
| Components | Dodecenyl Succinic | — | 536 | 536 | 365 | — |
| | Anhydride | | | | | |
| | Sebacic Acid | — | — | — | — | 266 |
| | Fumaric Acid | — | 928 | 928 | — | — |
| | Trimellitic Anhydride | — | 384 | 384 | 166 | 199 |
| Catalysts | Titanium Isopropylate | 97 | 95 | — | 97 | — |
| | Triethanolaminate | | | | | |
| | Tin 2-Ethyl Hexanoate | — | — | 95 | — | — |
| | Dibutyltin Oxide | — | — | — | — | 97 |

In Table 1, BPA-PO and BPA-EO are abbreviations for polyoxypropylene(2.05)-2,2-bis(4-hydroxyphenyl)propane and polyoxyethylene(2.05)-2,2-bis(4-hydroxyphenyl)propane, respectively.

The above-obtained polyester resins 1 to 5 were subjected to the following measurements. The results are shown in Table 2.

### Softening Point

Using a flow tester (CFT-500D manufactured by Shimadzu Corporation), 1 g of a sample (polyester resin) was applied with a load of 1.96 MPa by a plunger while being heated at a temperature rising rate of 6 degrees C./min and extruded from a nozzle having a diameter of 1 mm and a length of 1 mm. The amount of drop of the plunger of the flow tester was plotted against the temperature, and the temperature at which half the sample had flowed out was taken as the softening point.

### Glass Transition Temperature

Using a differential scanning calorimeter (Q-100 manufactured by TA Instruments Japan Inc.), 0.01 to 0.02 g of a sample (polyester resin) weighed in an aluminum pan was heated to 200 degrees C. and cooled to 0 degrees C. at a temperature falling rate of 10 degrees C./min. Subsequently, the sample was heated at a temperature rising rate of 10 degrees C./minute and subjected to a measurement. The glass transition temperature was determined as a temperature at the intersection of an extended line of a base line of the endothermic curve at or below the temperature of the highest peak, and a tangent line of the endothermic curve which indicates the maximum slope between the peak rising portion and the peak top.

### Acid Value

The acid value was measured by a method according to JIS (Japanese Industrial Standards) K0070 except for changing the measurement solvent from the mixed solvent of ethanol and ether defined in JIS K0070 to another mixed solvent of acetone and toluene (acetone:toluene=1:1 (by volume)).

### Weight Average Molecular Weight

The weight average molecular weight was measured by gel permeation chromatography (GPC). The columns were stabilized in a heat chamber at 40 degrees C. Tetrahydrofuran (THF) as a solvent was let to flow in the columns at that temperature at a flow rate of 1 mL per minute, and 50 to 200 μL of a THF solution of a sample (polyester resin) having a sample concentration of from 0.05% to 0.6% by mass was injected therein. The molecular weight of the sample was determined by comparing the molecular weight distribution of the sample with a calibration curve that had been compiled with several types of monodisperse polystyrene standard samples, showing the relation between the logarithmic values of molecular weights and the number of counts.

The polystyrene standard samples were those having molecular weights of 6×10², 2.1×10², 4×10², 1.75×10⁴, 5.1×10⁴, 1.1×10⁵, 3.9×10⁵, 8.6×10⁵, 2×10⁶, and 4.48×10⁶, respectively, available from Pressure Chemical Company (those available from Tosoh Corporation are also usable). Since the calibration curve is preferably prepared using at least 10 standard polystyrene samples, the above polystyrene standard samples were used in the present disclosure. As the detector, a refractive index (RI) detector was used.

TABLE 2

| | Poly- | Poly- | Poly- | Poly- | Poly- |
|---|---|---|---|---|---|
| | ester | ester | ester | ester | ester |
| | Resin 1 | Resin 2 | Resin 3 | Resin 4 | Resin 5 |
| Softening Point | 131 | 130 | 131 | 132 | 131 |
| (degrees C.) | | | | | |
| Glass Transition | 68 | 69 | 68 | 69 | 68 |
| Temperature | | | | | |
| (degrees C.) | | | | | |
| Acid Value | 4.5 | 4.8 | 5.3 | 4.9 | 4.8 |
| (mgKOH/g) | | | | | |
| Weight Average | 17200 | 17000 | 17200 | 17400 | 17100 |
| Molecular | | | | | |
| Weight (Mw) | | | | | |

### Example 1

Polyester resin 1: 90 parts

Carbon black: MOGUL L (manufactured by Cabot Corporation): 6 parts

Release agent: Carnauba wax (manufactured by TOA KASEI CO., LTD.): 3 parts

Metal-containing azo dye: T-77 (manufactured by Hodogaya Chemical Co., Ltd.): 1.2 parts

Quaternary ammonium salt compound: BONTRON P-51 (manufactured by Orient Chemical Industries Co., Ltd.): 0.5 parts

The above materials were mixed by a mixer, melt-kneaded by a two-roll mill at 50 degrees C. for 40 minutes, cooled, coarsely pulverized by a hammer mill, and then finely pulverized by an air jet pulverizer to obtain fine particles. The fine particles were classified by size to obtain mother toner particles having a weight average particle diameter of 7.5 μm containing ultrafine particles having a particle size of 5 μm or less in an amount of 20% by number.

Next, 2.0 parts of a silica (RY50 manufactured by Nippon Aerosil Co., Ltd., having a median diameter of 30 nm) as an additive and 100.7 parts of the mother toner particles were mixed together to obtain a toner of Example 1.

### Examples 2 to 8 and Comparative Examples 1 to 8

The toners of Examples 2 to 8 and Comparative Examples 1 to 8 were obtained in the same manner as in Example 1 except that the composition of the toner was changed to those described in Table 3.

TABLE 3

| | | | | | | | Metal- | | Quaternary | | | |
|---|---|---|---|---|---|---|---|---|---|---|---|---|
| | | | | | | | containing | | Ammonium | | | |
| | Polyester | | | | | | Azo | | Salt | | | |
| | Resin | | Carbon Black | | Release Agent | | Dye | | Compound | | Silica | |
| | | Parts | | Parts | | Parts | | Parts | | Parts | | Parts |
| | | by | | by | | by | | by | | by | | by |
| | No. | mass | Type | mass | Type | mass | Type | mass | Type | mass | Type | mass |
| Example 1 | 1 | 90 | MOGULL | 6 | Carnauba | 3 | T-77 | 1.2 | P-51 | 0.5 | RY50 | 2.0 |
| | | | | | wax | | | | | | | |
| Example 2 | 2 | 90 | MOGULL | 6 | Rice wax | 3.5 | T-77 | 1.3 | P-51 | 0.5 | H20TD | 2.0 |
| Example 3 | 3 | 90 | MOGULL | 6 | Carnauba | 3 | T-77 | 1.1 | P-51 | 0.5 | H05TD | 2.0 |
| | | | | | wax | | | | | | | |
| Example 4 | 4 | 90 | MOGULL | 6 | Rice wax | 3.5 | T-77 | 1.2 | P-51 | 0.5 | RY50 | 2.0 |
| Example 5 | 1 | 90 | MOGULL | 6 | Carnauba | 3 | T-77 | 1.2 | P-51 | 0.5 | H30TM | 2.0 |
| | | | | | wax | | | | | | | |
| Example 6 | 1 | 90 | MOGULL | 6 | Carnauba | 3 | T-77 | 1.2 | P-51 | 0.5 | H05TM | 2.0 |
| | | | | | wax | | | | | | | |
| Example 7 | 1 | 90 | MOGULL | 6 | Carnauba | 3 | T-77 | 1.2 | P-51 | 0.5 | H05TD | 2.0 |
| | | | | | wax | | | | | | | |
| Example 8 | 1 | 90 | MOGULL | 6 | Carnauba | 3 | T-77 | 1.2 | P-51 | 0.5 | NHM- | 2.0 |
| | | | | | wax | | | | | | 3N | |
| Comparative | 1 | 90 | MOGULL | 6 | Carnauba | 3 | T-77 | 1.2 | — | — | RY50 | 2.0 |
| Example 1 | | | | | wax | | | | | | | |
| Comparative | 1 | 90 | MOGULL | 6 | Carnauba | 3 | — | — | P-51 | 0.5 | RY50 | 2.0 |
| Example 2 | | | | | wax | | | | | | | |
| Comparative | 5 | 90 | MOGULL | 6 | Carnauba | 3 | T-77 | 1.2 | P-51 | 0.5 | RY50 | 2.0 |
| Example 3 | | | | | wax | | | | | | | |
| Comparative | 1 | 90 | MOGULL | 6 | Carnauba | 3 | T-77 | 1.2 | P-51 | 0.5 | RY50 | 2.0 |
| Example 4 | | | | | wax | | | | | | | |
| Comparative | 1 | 90 | MOGULL | 6 | Carnauba | 3 | T-77 | 1.2 | P-51 | 0.5 | NHM- | 2.0 |
| Example 5 | | | | | wax | | | | | | 3N | |
| Comparative | 1 | 90 | MOGULL | 6 | Carnauba | 3 | X-11¹⁾ | 1.2 | N-71²⁾ | 0.5 | RY50 | 2.0 |
| Example 6 | | | | | wax | | | | | | | |
| Comparative | 1 | 90 | MOGULL | 6 | Carnauba | 3 | T-77 | 1.2 | N-71²⁾ | 0.5 | RY50 | 2.0 |
| Example 7 | | | | | wax | | | | | | | |
| Comparative | 1 | 90 | MOGULL | 6 | Carnauba | 3 | X-11¹⁾ | 1.2 | P-51 | 0.5 | RY50 | 2.0 |
| Example 8 | | | | | wax | | | | | | | |

¹⁾“X-11” described in the column of “Metal-containing Azo Dye” for Comparative Examples 6 and 8 stands for “BONTRON X-11 (manufactured by Orient Chemical Industries Co., Ltd.)” that is a salicylic acid compound (not a metal-containing azo dye).
²⁾“N-71” described in the column of “Quaternary Ammonium Salt Compound” for Comparative Examples 6 and 7 stands for “BONTRON N-71 (manufactured by Orient Chemical Industries Co., Ltd.)” that is an azine compound (not a quaternary ammonium salt compound).

The type, name of the manufacturer, median diameter, and type of the surface treatment agent of the silica used in the Examples are shown in Table 4.

TABLE 4

| | Median | Surface | |
|---|---|---|---|
| Silica | Diameter | Treatment | |
| Type | (nm) | Agent | Manufacturer's Name |
| RY50 | 30 | PDMS | Nippon Aerosil Co., Ltd. |
| H30TM | 8 | HMDS | WACKER-CHEMIE |
| H05TM | 50 | HMDS | GMBH |
| H030TD | 8 | PDMS | |
| H20TD | 12 | PDMS | |
| H05TD | 50 | PDMS | |
| NHM-3N | 125 | HMDS | Tokuyama Corporation |

The surface treatment agents in the above table are as follows.
PDMS: Polydimethylsiloxane.
A type of silicone.
HMDS: Hexamethyldisilazane.

The physical properties of the toner and the silica were measured as follows.

### Average Particle Diameter (Median Diameter)

The median diameter of the silica was measured by observing the toner to the surface of which the external additive was adhered.

The measurement was carried out using a scanning electron microscope SU8200 series (available from Hitachi High-Technologies Corporation). The obtained image was binarized with an image processing software program A-zou-kun (available from Asahi Kasei Engineering Corporation). For each of the external additive particles in the obtained image, the diameter of a true circle having the same area was calculated to determine the median diameter.

### Volume Average Particle Diameter of Toner

First, 0.1 to 5 mL of a surfactant (an alkylbenzene sulfonate) was added to 100 to 150 mL of an electrolyte solution and 2 to 20 mg of a measurement sample was added thereto. The electrolyte solution in which the measurement sample was suspended was subjected to a dispersion treatment with an ultrasonic disperser for 1 to 3 minutes, and a volume-based particle size distribution in the range of 2 to 40 μm was measured by a Coulter Counter IIe equipped with a 100-μm aperture.

### Proportion of Ultrafine Particles of 5 μm or Less in Toner

The proportion of particles having an equivalent circle diameter of from 0.6 to 5.0 μm based on number was measured using a flow particle image analyzer FPIA-3000 manufactured by SYSMEX CORPORATION.

A 1% by mass NaCl aqueous solution was prepared using the first-grade sodium chloride and then passed through a 0.45-μm filter. Next, 0.1 to 5 mL of a surfactant (an alkylbenzene sulfonate) as a dispersant was added to 50 to 100 mL of the 1% by mass NaCl aqueous solution passed through the filter, and 1 to 10 mg of a sample was further added thereto. The solution was subjected to a dispersion treatment with an ultrasonic disperser for 1 minute, and the resulting dispersion having a particle concentration of 5,000 to 15,000 particles/μL was subjected to a measurement. In the measurement of the number of particles, a two-dimensional image was obtained by a CCD camera for each particle and the diameter of the circle having the same area as each obtained image was calculated as the equivalent circle diameter. In view of the pixel accuracy of the CCD camera, particles having an equivalent circle diameter of 0.6 μm or more were deemed to be effective, and the number of such particles was measured.

The obtained toners were subjected to the following evaluations. Evaluation results are shown in Table 5.

### Average Circularity

The average circularity was measured by a flow particle image analyzer FPIA-3000 manufactured by SYSMEX CORPORATION.

First, 0.1 to 0.5 mL of a surfactant (an alkylbenzene sulfonate) as a dispersant was added to 100 to 150 mL of water from which impure solids has been removed in advance in a container. Further, about 0.1 to 0.5 g of a measurement sample was added thereto. The resulting suspension in which the sample was dispersed was subjected to a dispersion treatment with an ultrasonic disperser for about 1 to 3 minutes. The resulting dispersion liquid having a concentration of 3,000 to 10,000 particles/μL was subjected to a measurement of the average circularity using the above-described instrument. The circularity was determined by the following equation: Circularity=(Perimeter of the circle having an equal area to a projected area)/(Perimeter of the projected area).

### Evaluation of Charge Rising Property

First, 6 g of a carrier and a toner in an amount of 7% by mass of the carrier were weighed and mixed to prepare a developer. The developer was left to stand at a room temperature of 22 degrees C. and a humidity of 55% RH for 2 hours and sealed in a metal cylinder, then stirred at 280 rpm for 15 seconds or 60 seconds. After the stirring, 1 g of the developer was weighed in a 635 mesh gauge and subjected to a measurement of the charge amount of the toner with a V blow-off device (manufactured by Ricoh Creativity Development Co., Ltd.) by a single mode method. In the single mode method, according to the manual of the V blow-off device (manufactured by Ricoh Creativity Development Co., Ltd.), the blowing-off was performed twice at a height of 5 mm and a suction parameter of 100.

The carrier was a resin-coated ferrite carrier obtained by applying a coating film forming solution of an acrylic resin and a silicone resin containing alumina particles on the surface of a burnt ferrite powder (having a weight average particle diameter of 35 nm).

The charge amount after stirring for 15 seconds and 60 seconds were respectively denoted by Q15 and Q60 and the charge rising property was evaluated by the ratio of Q15/Q60 based on the following judgment criteria.

### Judgment Criteria

A: 0.7≤Q15/Q60

B: 0.3≤Q15/Q60<0.7

C: 0≤Q15/Q60<0.3

### Evaluation of Silica Adhesion and Surface Flaw on OPC (Photoconductor)

Using a commercially available printer SP-3610 (manufactured by Ricoh Co., Ltd.), a text image was output on 10,000 sheets such that the image density was adjusted to 6%, and the degrees of silica adhesion and surface flaw were thereafter evaluated based on the following judgment criteria.

Judgment Criteria

A: There are neither deposit derived from silica nor flaw on the surface of the OPC.

B: There are traces of deposits derived from silica and a few flaws on the surface of the OPC.

C: There are remarkable deposits derived from silica and flaws on the surface of the OPC.

### Image Quality

The image quality was comprehensively judged by the degree of deterioration of image quality (specifically, the degree of occurrence of defective transfer and defective OPC cleaning) after continuous output of images on sheets. The degree of occurrence of defective transfer was evaluated as follows. Using a commercially available printer SP-3610 (manufactured by Ricoh Co., Ltd.), a longitudinal band image having a width of 2 cm was continuously output on 1,000 A4-size sheets in the lateral direction, and a black solid image was thereafter output and visually observed to rank the degree of occurrence of defective transfer. The image quality was then evaluated based on the following judgment criteria. The degree of occurrence of defective OPC cleaning was evaluated as follows. Using a commercially available printer SP-3610 (manufactured by Ricoh Co., Ltd.), a longitudinal band image having a width of 2 cm was continuously output on 1,000 A4-size sheets in the lateral direction, and development of a black solid band image was thereafter performed but suspended, to transfer onto a piece of SCOTCH tape toner particles remaining on the photoconductor after cleaning by the cleaner. The piece of SCOTCH tape with the toner particles was stuck on a white paper sheet and reflection density (ID) thereof was measured by a spectrophotometer (X-Rite 938). Also, another piece of SCOTCH tape was stuck on the same white paper sheet and reflection density (ID) thereof was measured by the spectrophotometer. The ID of the tape with the toner particles on the white paper sheet was subtracted with the ID of only the tape on the white paper sheet to determine the difference therebetween. The cleaning performance can be judged by the difference thus obtained. That is, the smaller the difference, the better the cleaning performance.

Judgment Criteria

A: An abnormal image due to low image density caused by defective transfer or due to image contamination caused by defective cleaning is not observed.

B: Although within the range of practical use, image density decrease due to slightly defective transfer and image contamination due to slightly defective cleaning are observed.

C: Out of the range of practical use. Image density decrease or defect due to defective transfer and image contamination due to defective cleaning are observed.

D: Out of the range of practical use. Image density decrease or defect due to defective transfer and image contamination due to defective cleaning are remarkably observed.

TABLE 5

| | | | | Evaluation Results | | | |
|---|---|---|---|---|---|---|---|
| | | Proportion | | | | Silica | |
| | Volume | of | | | | Adhesion | |
| | Average | Ultrafine | | | | and | |
| | Particle | Particles | | Charge | Low | Surface | |
| | Diameter | of 5 μm or | Average | Rising | Environmental | Flaw on | Image |
| | (μm) | less (%) | Circularity | Property | Load | OPC | Quality |
| Example 1 | 7.4 | 20 | 0.85 | A | Yes | A | A |
| Example 2 | 7.6 | 17 | 0.95 | A | Yes | A | A |
| Example 3 | 7.4 | 20 | 0.85 | A | Yes | A | A |
| Example 4 | 7.5 | 19 | 0.94 | A | Yes | A | A |
| Example 5 | 7.6 | 17 | 0.85 | A | Yes | B | A |
| Example 6 | 7.6 | 17 | 0.85 | A | Yes | B | A |
| Example 7 | 7.7 | 16 | 0.95 | A | Yes | B | A |
| Example 8 | 7.5 | 19 | 0.85 | A | Yes | B | A |
| Comparative | 7.7 | 16 | 0.85 | C | Yes | A | A |
| Example 1 | | | | | | | |
| Comparative | 7.6 | 17 | 0.86 | C | Yes | A | A |
| Example 2 | | | | | | | |
| Comparative | 7.6 | 17 | 0.85 | A | No | A | A |
| Example 3 | | | | | | | |
| Comparative | 7.5 | 19 | 0.84 | A | Yes | A | C |
| Example 4 | | | | | | | |
| Comparative | 7.7 | 16 | 0.96 | A | Yes | B | D |
| Example 5 | | | | | | | |
| Comparative | 7.6 | 14 | 0.85 | C | Yes | A | A |
| Example 6 | | | | | | | |
| Comparative | 7.6 | 14 | 0.85 | C | Yes | A | A |
| Example 7 | | | | | | | |
| Comparative | 7.6 | 14 | 0.85 | C | Yes | A | A |
| Example 8 | | | | | | | |

In the evaluation results of “low environmental load” in the above table, “No” stands for a toner containing a polyester resin having Sn—C bond and “Yes” stands for a toner containing no polyester resin having Sn—C bond.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. A toner comprising:
a binder resin;
a metal-containing azo dye; and
a quaternary ammonium salt,
wherein the toner has an average circularity of from 0.85 to 0.95,
wherein the toner is free of a tin compound having Sn—C bond.

2. The toner according to claim 1, further comprising a silica containing a silicone oil, the silica having a median diameter of from 10 to 80 nm.

3. A toner storage unit comprising:
a container; and
the toner according to claim 1 stored in the container.

4. An image forming apparatus comprising:
an electrostatic latent image bearer;
an electrostatic latent image forming device configured to form an electrostatic latent image on the electrostatic latent image bearer;
a developing device containing the toner according to claim 1, configured to develop the electrostatic latent image formed on the electrostatic latent image bearer with the toner to form a toner image;
a transfer device configured to transfer the toner image formed on the electrostatic latent image bearer onto a surface of a recording medium; and
a fixing device configured to fix the toner image on the surface of the recording medium.
